(19) United States
(12) Patent Application Publication
(10) Pub. No.: US 2017/0279676 A1
(43) Pub. Date: Sep. 28, 2017

(54) TOPOLOGY-BASED VIRTUAL SWITCHING MODEL WITH PLUGGABLE FLOW MANAGEMENT PROTOCOLS

(71) Applicant: Futurewei Technologies, Inc., Plano, TX (US)

(72) Inventors: Yunsong Lu, Mountain View, CA (US); Yan Chen, Dublin, CA (US)

(73) Assignee: Futurewei Technologies, Inc., Plano, TX (US)

(21) Appl. No.: 15/077,461

(22) Filed: Mar. 22, 2016

(51) Int. Cl. H04L 12/24; H04L 12/891; H04L 12/931

(52) U.S. Cl. CPC H04L 41/0816; H04L 41/12; H04L 49/354; H04L 47/41

(57) ABSTRACT

The disclosure relates to technology for supporting multiple flow management protocols in a virtual network switch and changing a flow management protocol without changing switch topology configurations at run time. A data plane provider is detected via a pluggable software module (or plugin or plugin module) that identifies and controls the data plane provider with network interfaces and enables flow management protocols. A switch topology is then constructed by creating a virtual switch object, adding ports to the virtual switch object. A datapath is then created using the switch topology and the first flow management protocol on the data plane provider. Network interfaces are connect to each ports respectively to enable communication among the entities attached to each network interface according to the first flow management protocol. The datapath can be later changed to use the second flow management protocol and retain the same topology at run time.

### BACKGROUND

A network switch is a hardware device for making data connections among devices. Switches may be employed to receive, process and forward data packets to their intended destination according to specific flow management protocols (or called data forwarding protocols). Moreover, network switches can have two planes: a control plane and a data plane. The control plane is a portion of the system responsible for providing the flow management protocol functions and features of the system. The data plane is responsible for actually receiving, processing and sending data from and to the ports that connect the switch to external sources according to the logic provided by the control plane.

Network switches may be deployed as physical hardware or may be virtually deployed using software that provides network connectivity for systems employing virtualization technologies. Virtualization technologies allow one computer to do the job of multiple computers by sharing resources of a single computer across multiple systems. Through the use of such technology, multiple operating systems and applications can run on the same computer at the same time, thereby increasing utilization and flexibility of hardware. Virtualization allows servers to be decoupled from underlying hardware, thus resulting in multiple VMs sharing the same physical server hardware.

When any of the multiple virtual computer systems communicate one with another, they can communicate within the single physical computing device via the virtual switch. In other words, network traffic with a source and destination within the single physical computing device do not exit the physical computer system.

With network virtualization technology being widely adopted, virtual switch functionalities, protocols, hardware accelerators, etc. are emerging quickly. Under many circumstances, different virtual switch implementations with different protocols from different vendors may be used in a single system, which makes switch configuration tasks complicated or even impossible.

### BRIEF SUMMARY

In one embodiment, there is a method for supporting multiple flow management protocols in a virtual network switch (vSwitch), comprising detecting a data plane provider, the data plane provider discoverable via a pluggable software module that identifies a data plane of the data plane provider with one or more network interfaces and enables one or more flow management protocols; and configuring a virtual switch to use a first flow management protocol of the one or more flow management protocols enabled by the pluggable software module by constructing a topology of the virtual switch by creating a virtual switch object on a virtual switch framework, and adding one or more ports to the virtual switch to form the topology; creating a first datapath on the data plane provider using the topology with the first flow management protocol; and connecting a first network interfaces of the one or more network interfaces to a first port of the one or more ports and a second network interface of the one or more network interfaces to a second port of the one or more ports to enable communication among one or more entities attached to each of the network interfaces by forwarding data packets within the first datapath using the first flow management protocol.

In another embodiment, there is a non-transitory computer-readable medium storing computer instructions for supporting multiple protocols in a network, that when executed by one or more processors, perform the steps of detecting a data plane provider, the data plane provider discoverable via a pluggable software module that identifies a data plane of the data plane provider with one or more network interfaces and enables one or more flow management protocols; and configuring a virtual switch to use a first flow management protocol of the one or more flow management protocols enabled by the pluggable software module by constructing a topology of the virtual switch by creating a virtual switch object on a virtual switch framework, and adding one or more ports to the virtual switch to form the topology; creating a first datapath on the data plane provider using the topology with the first flow management protocol; and connecting a first network interfaces of the one or more network interfaces to a first port of the one or more ports and a second network interface of the one or more network interfaces to a second port of the one or more ports to enable communication among one or more entities attached to each of the network interfaces by forwarding data packets within the first datapath using the first flow management protocol.

In still another embodiment, there is a node for supporting multiple protocols in a network, comprising a memory storage comprising instructions; and one or more processors coupled to the memory that execute the instructions to: detect a data plane provider, the data plane provider discoverable via a pluggable software module that identifies a data plane of the data plane provider with one or more network interfaces and enables one or more flow management protocols; and configure a virtual switch to use a first flow management protocol of the one or more flow management protocols enabled by the pluggable software module by constructing a topology of the virtual switch by creating a virtual switch object on a virtual switch framework, and adding one or more ports to the virtual switch to form the topology; creating a first datapath on the data plane provider using the topology with the first flow management protocol; and connecting a first network interfaces of the one or more network interfaces to a first port of the one or more ports and a second network interface of the one or more network interfaces to a second port of the one or more ports to enable communication among one or more entities attached to each of the network interfaces by forwarding data packets within the first datapath using the first flow management protocol.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 illustrates a processing environment for a group of computing devices connected to a management station via a network switch.

FIG. 2 illustrates a virtual switching management system having pluggable flow management protocols.

FIG. 3 illustrates a unified modeling language (UML) static class diagram of a data model for the virtual switch framework of FIG. 2.

FIG. 4 illustrates a sequence diagram for changing and discovering flow management protocols of providers.

FIG. 5 illustrates a sequence diagram for creating a switch associated with the discovered data plane providers of FIG. 4.

FIG. 6 illustrates one embodiment of a flow diagram for configuring a virtual switch with multiple protocols using a pluggable software module in accordance with FIG. 1-5.

FIG. 7 illustrates another flow diagram for configuring a virtual switch with multiple protocols using a pluggable software module (plugin) in accordance with FIG. 1-5.

FIG. 8 illustrates a block diagram of a network system that can be used to implement various embodiments.

### DETAILED DESCRIPTION

The disclosure relates to technology for a virtual switch framework that uses a unified topology management interface and supports multiple data plane providers with different flow management protocols enabled by dynamically pluggable modules.

Multiple flow management protocols are supported in a virtual network switch and a flow management protocol may be changed to another protocol without changing switch topology configurations at run time. A data plane provider is detected via a pluggable software module (or plugin or plugin module) that identifies and controls the data plane provider with network interfaces and flow management protocols. A switch topology is then constructed by creating a virtual switch object, adding ports to the virtual switch object. A datapath is then created using the switch topology and the first flow management protocol on the data plane provider. Network interfaces are connect to each ports respectively to enable communication among the entities attached to each network interface according to the first flow management protocol. The datapath can be later changed to use the second flow management protocol and retain the same topology at run time.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

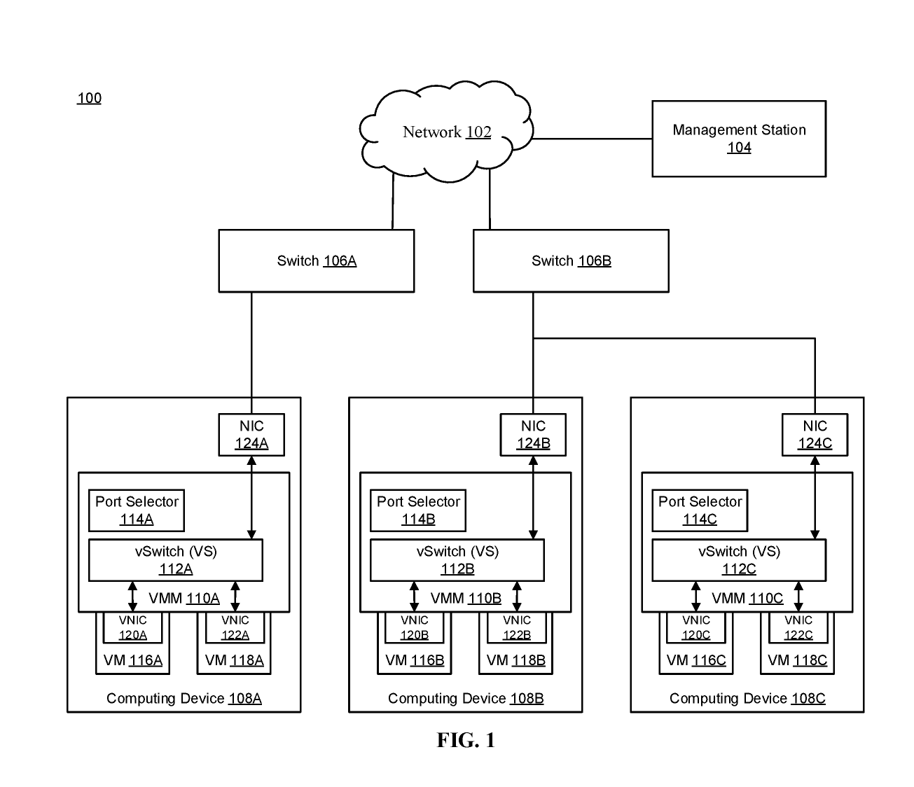

FIG. 1 illustrates a processing environment for a group of computing devices connected to a management station via a network switch. As illustrated, the processing environment 100 includes, but is not limited to, network 102, management station 104, switches 106A, 106B and computing devices 108A, 108B, 108C. It is appreciated that the illustrated embodiment is intended as an example, and that any number of computing devices, switches, networks and management stations may be employed.

The network 102 may be any public or private network, or a combination of public and private networks such as the Internet, and/or a public switched telephone network (PSTN), or any other type of network that provides the ability for communication between computing resources, components, users, etc., and is coupled in the example embodiment to a respective one of switches 106A, 106B. Each of the switches 106A, 106B (which may be physical or virtual) includes a respective forwarding data structure (e.g., a forwarding information base (FIB) or forwarding table, not shown) by which switches 106A, 106B forward incoming data packets toward a destination based upon, for example, OSI Layer 2 addresses (e.g., based on MAC addresses) contained in the packets.

The computing devices 108A, 108B, 108C, such as a host, are coupled to a respective one of the switches 106A, 106B. Each of the computing devices 108A, 108B, 108C respectively includes, for example, a virtual machine (VM) 116A/118A, 116B/118B, 116C/118C and a virtual machine monitor (VMM) or hypervisor 110A, 110B, 110C and a network interface card (NIC) 124A, 124B, 1224C. Each of the VMMs 110A, 110B, 110C include, for example, a virtual switch or vSwitch (VS) 112A, 112B, 112C and a port selector 114A, 114B and 114C. The VMs 116A/B, 116B/118B, 116C/118C each include a corresponding NIC 120A/122A, 120B/122B, 120C/122C, such as a virtual NIC (vNIC). It is appreciated that the components, such as the NIC, vNIC, Switch, vSwitch, etc., may be exchanged or replaced with either physical or virtual components, or any combination of hardware and/or software.

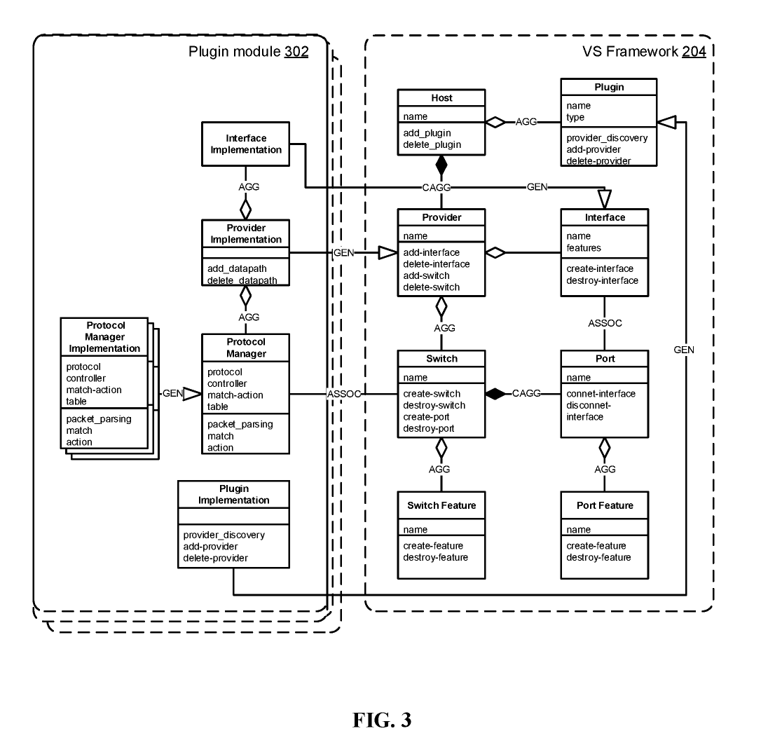

Each computing device 108A, 108B and 108C executes a respective one of VMMs 110A, 110B, 110C, which virtualizes and manages resources on the respective computing device 108A, 108B and 108C. The computing devices 108A, 108B and 108C may be any type of device, such as a server or router, which may implement the procedures and processes described herein as detailed in FIGS. 3-8 below. Moreover, the computing devices 108A, 108B and 108C for example, may execute the VMMs 110A, 110B, 110C under the direction of a human and/or automated cloud administrator at a management station 104 coupled to the computing devices 108A, 108B and 108C by network 102.

VMMs 110A, 110B, 110C on computing devices 108A, 108B, 108C support the execution and operation of VMs 116A/118A, 116B/118B, 118C/118C, and implement VSs 112A, 112B, 112C and port selectors 114A, 114B, 114C in support of respective VMs. The port selectors 114A, 114B, 114C determine the type of the ports of the VSs 112A, 112B, 112C and ensure proper connection of the NICs 124A, 124B, 124C to the network 102. It should also be appreciated the while two VMs are illustrated as being deployed on each of the computing devices, any number of VMs and interfaces may be employed in the computing devices. Each of the VMs 116A, 116B, 116C may be associated with various entities, such as data providers or consumers (explained further below).

VMs 116A/118A, 116B/118B, 116C/118C each include a respective vNIC 120A/122B, 120B/122b, 120C/122C. A vNIC 120A/122B, 120B/122B, 120C/122C facilitates communication via a port of a particular VS. Communications between VMs 116A, 118A, 116B, 118B, 116C, 118C may be routed via software of VSs 112A, 112B, 112C and physical switches 106A, 106B.

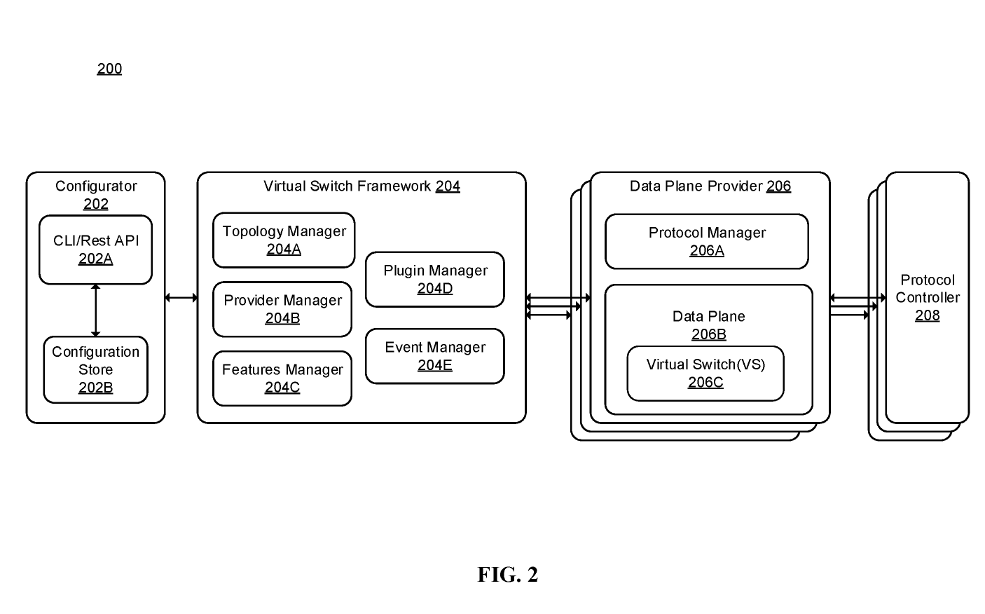

FIG. 2 illustrates a virtual switching management system having pluggable flow management protocols. The virtual switching management system 200 includes, for example, a configurator 202, a virtual switch framework 204, a data plane provider 206 and a protocol controller 208. A data plane provider may be any hardware or software module which can receive, process and send data packets with the logic (flow management protocols) prescribed by its controller. With this system, multiple protocols from various data plane providers may be supported. Thus, the system is not limited to a layer 2 or layer 3 switch or similar, but may also include other types of flow management protocols such as openflow or a fully customizable switching policy. Whereas traditional virtual switch implementations are designed to support data plane provider specific flow management protocols, the management system 200 provides a framework to support multiple data plane providers with different flow management protocols enabled by pluggable software modules (i.e., plugin or plugin module), and the flow management protocol of a running virtual switch can be changed without changing the already configured switching topologies. Flow management protocols can therefore be changed or modified at runtime, and multiple switch instances can support different protocols at the same time.

The configurator 202 includes a command line interface (CLI) and/or application programming interface (API) 202A that enables a user of the system to configure and manage the virtual switch objects and their respective topologies. The configurator 202 is also responsible for maintaining the configuration records. Such records may be stored in configuration store 202B. The configuration store 202B may be, for example, a database, memory, storage system or any other component or element capable of storing information. Moreover, the configuration storage 202B may reside outside of the configurator 202 as independent storage or on any other system component that is in communication with the management system 200.

VS framework 204 includes virtual switch topology configuration and switch object management functionality. As noted above, the VS on the framework 204 may be configured (or re-configured) by the configurator 202. The VS framework 204 includes, but is not limited to, a topology manager 204A, a provider manager 204B, a features manager 204C, a plugin manager 204D and an event manager 204E. The topology manager 204A is responsible for configuring and managing data plane objects and their topologies (namely the virtual switches and their ports and connected interfaces).

The provider manager 204B is responsible for discovering and managing specific instances of the data plane providers 206 using, in some embodiments, various software and/or hardware co-processors and accelerators. Thus, the provider manager 204B may identify data plane providers 206 via the plugin modules which enable and manage their respective providers and protocols. The provider manager 204B may also monitor for newly added plugins to assist in discovering and managing instances of the new protocols and data plane providers 206. Once discovered, the data plane providers 206 and their respective plugins may be configured to interface with and operate on the virtual switching management system 200, or to otherwise enable or make available any new functionality.

The features manager 204C manages common features of the data plane objects, such as monitoring protocols, quality of service, etc. However, the features manager 204C is not typically responsible for features related to the flow management protocols. In general, the features manager 204C will be responsible for making decisions about whether a data plane provider 206 implements certain features and requests execution of those features when appropriate. In one embodiment, the features manager 204C may be responsible for managing the creation and removal of switching and port features.

The plugin manager 204D manages the pluggable software modules (plugins) to enable the data plane provider's 206 flow management protocols. The plugin manager 204D is responsible for integrating functionality from the plugins.

The plugin manager 204D may also be responsible for loading plugins. In another embodiment, the plugin manager 204D may apply loading criteria such that specific plugins meeting the loading criteria are loaded. For example, loading criteria may include a timestamp (e.g., load plugins created after a specific date), version number (e.g., load the latest version number of a plugin if multiple versions are present), or specific names of data plane providers 206.

The plugin manager 204D may also assist in determining which plugins to load and gather information necessary to load selected plugins. The plugin manager 204D may also receive configuration data from the configuration store 202B of configurator 202.

Plugins may have a common interface that enables it to be loaded by plugin manager. Each plugin is to perform specific functions (e.g., enable flow management protocols) or to perform specific configuration tasks and/or provide specific information to communicate with various components in the system. When a plugin is loaded, any plugin-specific initialization may also be performed. Examples of plugin-specific initialization include creating and/or verifying communication connections, loading classes, directing plugin manager 204D to load or unload additional plugins, etc.

The event manager 204E is responsible for handling events at runtime and scheduling tasks for the virtual switch framework 204.

Data plane provider 206 is responsible for providing provider-specific flow management protocols and implementing APIs to interactive with the virtual switch framework 204. The data plane provider 206 includes a protocol manager 206A and data plane 206B. The data plane providers 206 may be represented by the pluggable software modules (plugins) that may be implemented as specific flow management protocols and which implement APIs to interact with the VS framework 204. These plugins may enable the data plane 206B to forward packets of information based on the flow management protocols defined by the plugin.

As appreciated, the data plane 206B may receive packets, process and forward packets in a manner using the flow management protocols provided by the data plane provider. Specifically, the data plane is responsible for the ability of a computing device, such as a router or server, to process and forward packets, which may include functions such as packet forwarding (packet switching), which is the act of receiving packets on the computing device's interface. The data plane 206B may also be responsible for classification, traffic shaping and metering.

The plugins enable the respective data plane providers 206 to implement data forwarding functionalities according to predefined or customized flow management protocols. In one embodiment, each plugin may be a stand-alone software library module that is independent from the VS framework 204. Such independent plugins may be added and/or removed. In another embodiment, one or more plugins may rely on the VS framework 204 to provide additional functionality.

FIG. 3 illustrates a unified modeling language (UML) static class diagram of a data model for the virtual switch framework of FIG. 2. The model allows the VS framework 204 to be implemented to support multiple virtual switches on different data plane providers with different flow management protocols enabled by respective plugin modules, and to support changing flow management protocols without changing switch topology configurations.

A class describes a set of objects that share the same specifications of features, constraints, and semantics. For example, the object for a plugin contains the class “plugin,” with attributes “name, type” and method of execution as “provider_discovery,” “add_provider” and “delete_provider.” In addition, relationships may exist between objects such that connections are found in a class and object diagram. Relationships depicted in the diagram of FIG. 3 are as follows. An association (ASSOC) specifies a semantic relationship that can occur between typed instances. Aggregation (AGG) is more specific than an association, such as an association that represents a part-whole or part-of relationship. An association (ASSOC) may represent a composite aggregation (i.e., a whole/part relationship). Composite aggregation (CAGG) is a strong form of aggregation that requires a part instance be included in at most one composite at a time, and a composition is represented by the attribute on the part end of the association being set to true. The graphical representation of a composition relationship is a filled diamond shape on the containing class end of the tree of lines that connect contained class(es) to the containing class. A generalization (GEN) is a taxonomic relationship between a more general classifier and a more specific classifier. The graphical representation of a generalization is a hollow triangle shape on the superclass end of the line that connects it to one or more subtypes.

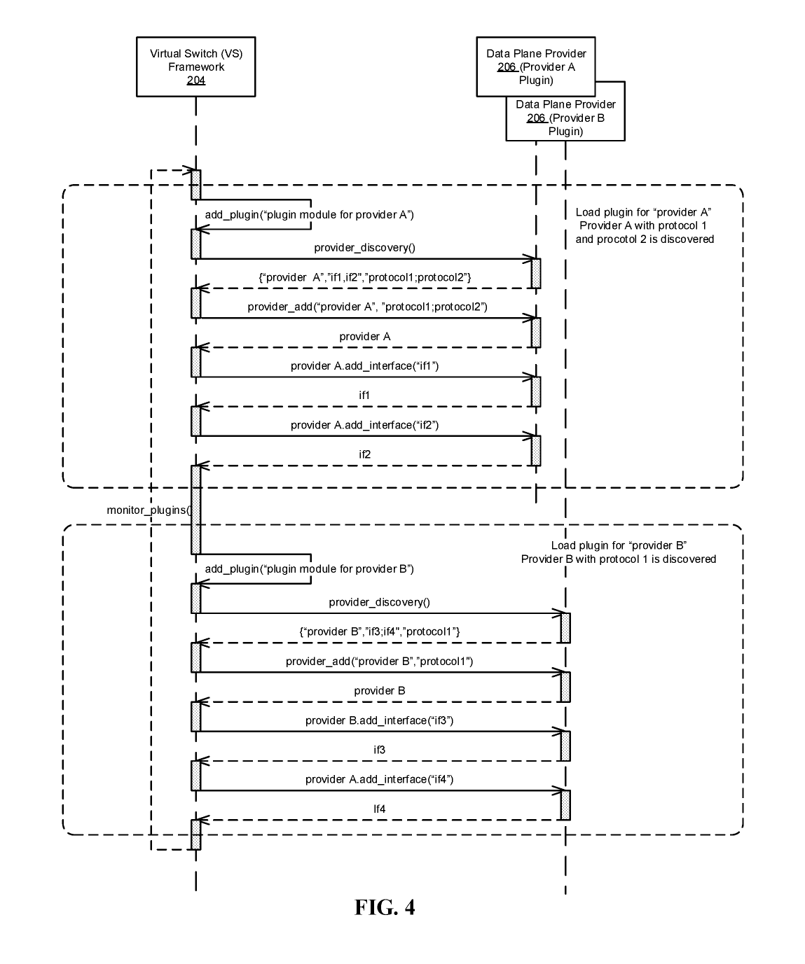

FIG. 4 illustrates a sequence diagram for loading plugins, discovering providers and the flow management protocols they support. Implementing the process of FIG. 4 allows the virtual switching management system 200 to dynamically add, change or modify protocols from at least a first protocol to at least one other protocol. In the discussion that follows, VS framework 204 performs the process detailed in the sequence diagram in association with the data plane 206B of data plane provider 206 (e.g., provider A and provider B). However, it is appreciated that such operation is not limited to the aforementioned components. Moreover, the process disclosed in FIG. 4 is one example of discovering providers with different flow management protocols. It is therefore appreciated that the process disclosed is a non-limiting example.

In the example depicted in FIG. 4, after the plugin manager of VS framework 204 finds and then calls add_plugin (“plugin module for provider A”) to load the plugin which enables the provider A 206A with specific flow management protocols, such as protocol 1 and protocol 2. The VS framework 204 then calls the “provider_discovery( )” of the newly added (or modified) plugin to obtain the property information of the provider. The data plane provider A 206 that is enabled by the plugin returns the name of the provider, along with the associated network interface(s) and flow management protocol(s) it supports. For example, data plane provider 206 (provider A) has two network interfaces (“if1” and “if2”) and supports two flow management protocols (“protocol1” and “protocol2”), and returns {“provider A”, “if1, if2”, “protocol1 and protocol2”}. Upon the data plane provider A 206 returning the information to the VS framework 204, the VS framework 204 registers the provider A with the property information, including the supported protocols and associated network interfaces for later use by calling methods such as “provider_add( ),” and “providerA.add_interface( ).”

A similar process occurs for the discovery of another data plane provider 206, such as provider B. In this example, provider B has two network interfaces (“if3” and “if4”) and a single flow management protocol (“protocol1”), which information is stored for example in a plugin module of data plane provider 206.

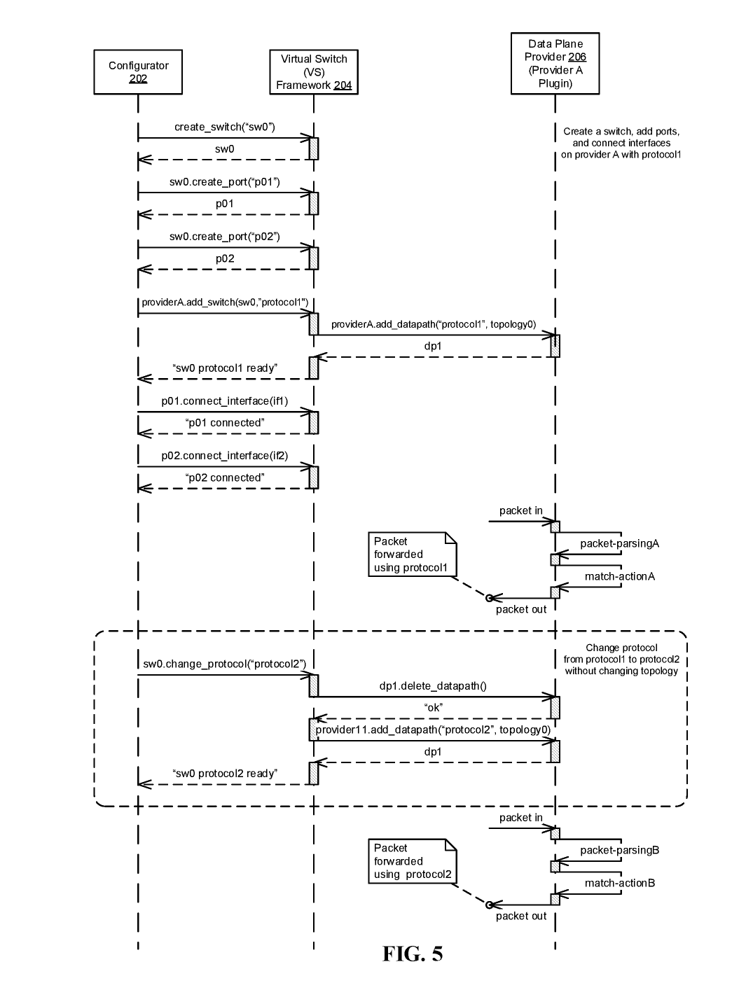

FIG. 5 illustrates a sequence diagram for creating a switch associated with the discovered data plane providers of FIG. 4. In the example embodiment, a switch is created such that a protocol being used for communication between entities may be changed, for example during runtime, to a newly discovered protocol without affecting the switch topology configuration. In the explanation that follows, the configurator 202, VS framework 204 and data plane provider 206 are responsible for implementing the process. However, it is appreciated that implementation is not limited to these components.

The process of creating the switch is initiated by configurator 202 first constructing a switch topology. For example, a switch topology “topology0” can be constructed by the following process: the configurator 202 calls “create_switch(“sw0”) to instruct the VS framework 204 to create the switch object (“sw0”), and then calls “sw0.create_port(“p01”)” to create a first port (“p01”) associated with the switch. Similarly, a second port (“p02”) is created associated with the switch object (“sw0”). It is appreciated that the two ports are an example, and that any number of ports may be associated with the switch. In one embodiment, the number of ports created correspond to the number of network interfaces on the data plane provider 206 to be used.

Once the switch object (“sw0”) and associated topology “topology0” have been created, the configurator 202 may call “providerA.add_switch(sw0, “protocol1”)” to instruct the VS framework 204 to create the switch on the data plane provider 206 (provider A) using the first protocol (protocol1).

The VS framework 204 then sends a request to the data plane provider 206 (“providerA.add_datapath(“protocol1”, “topology0”) to create a datapath (dp1). The creation of the datapath (dp1) from the data plane provider 206 (provider A) to the VS framework 204 means the switch (“sw0”) is now ready for forwarding data between the ports according to “protocol1” along the datapath dp1 (after interfaces are connected to ports). The configurator 202 can instruct the VS framework 204 to connect the first port (“p01”) to the first network interface (“if1”) by calling “p01.connect_interface(if1).” Similarly, the configurator 202 can instruct the VS framework 204 to connect the second port (“p02”) to the second network interface (“if2”) by calling “p02.connect_interface(if2).”

The virtual switch (VS) 206C may now be used to send data packets using the flow management protocol (in this case, protocol1) of the data plane provider 206 (in this case, provider A). Thus, entities may now communicate with one another via the first (“if1”) and second (“if2”) network interfaces connected to the ports of virtual switch (VS) 206C with the designated flow management protocol “protocol1.” For example, a VM 116A may send a data packet via the virtual switch (VS) 206C to another VM 118A using protocol1 along the datapath dp1 via vNIC 120A and vNIC 122A. As data packets arrive at the virtual switch (VS) 206C created on behalf of the data plane provider 206 (provider A), they may be parsed (e.g., determine a destination address of the packet) and matched to specific actions and forwarded using the flow management protocol (e.g., protocol1) by the data plane 206B.

It is appreciated that while two VMs are communicating in the disclosed embodiment, any number of VMs may be communicating through any number of network interfaces and ports, and the disclosed embodiment is a non-limiting example.

When a user wants to change flow management protocols, the virtual switch management system 200 may change flow management protocols without changing the topology of the virtual switch (VS) 206C. In particular, the configurator 202 requests a change in flow management protocol from protocol to protocol2, such as “sw0.change_protocorprotocol2”), to the VS framework 204. The VS framework 204, in response to the request from the configurator 202, forwards the request to remove the first datapath (dp1) to the data plane provider 206 (provider A), such as in the form of the following instruction “dp1.delete_datapath( ).”

In response to the instruction, the datapath (dp1) is removed and the VS framework 204 requests that a new datapath (also, dp1) be created using the second flow management protocol (protocol2) without changing the topology (topology0). Once the datapath (dp1) is created, the switch (“sw0”) is ready to communicate using the second flow management protocol (protocol2). Notably, there is no need to create or re-create the virtual switch (“sw0”) in order to change flow management protocols. That is, the switch remains connected using the previously created topology and may now be used to send data packets using the new flow management protocol (in this case, protocol2) of the data plane provider 206 (in this case, provider A). Thus, entities (such as VMs) may now communicate with one another using the virtual switch (VS) 206C with the newly designated flow management protocol (in this case, protocol2).

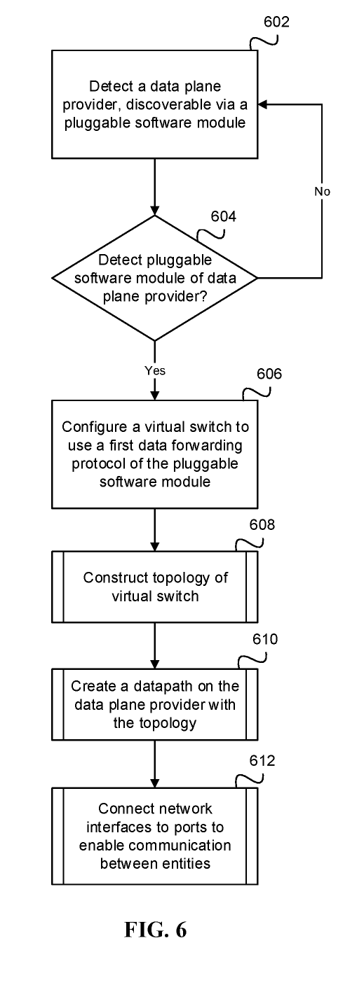

FIG. 6 illustrates one embodiment of a flow diagram for configuring a virtual switch with multiple protocols using a pluggable software module in accordance with FIGS. 1-5. At 602, the VS framework 204 monitors the virtual switching management system 200 to detect data plane providers by discovering newly created or modified plugins. The VS framework 204 continues to monitor for plugins until detection (discovery) of a plugin of a data plane provider 206. At 604, the VS framework 204 determines whether a plugin of a data plane provider 206 has been detected. If no plugin is detected at 604, the process continues to monitor for detected plugins at 602. Otherwise, when the VS framework 204 detects a new plugin, the newly added functionalities including flow management protocols enabled by the plugin can be used for configuring a new virtual switch or modifying an existing virtual switch (VS) 206C at 606.

As part of configuring the virtual switch (VS) 206C at 606, a topology (e.g., topology0) is constructed at 608 by creating a virtual switch object on the VS framework 204, and adding one or more ports to the virtual switch (VS) 206C. After the topology is constructed, a datapath (e.g. dp1) is created on the data plane provider 206 using the topology (topology0) and the flow management protocol at 610. Then, at 612, the virtual switch (VS) 206C is ready to perform according to the flow management protocol as set forth in the plugin by connecting the network interface(s) to corresponding port(s) to enable communication of entities attached to the network interface(s) by implementing the flow management protocol along the datapath. Accordingly, a first entity (e.g., VM 116A) may communicate via vNIC 120A with a second entity (e.g. VM 118A) via vNIC 122A using a specified flow management protocol.

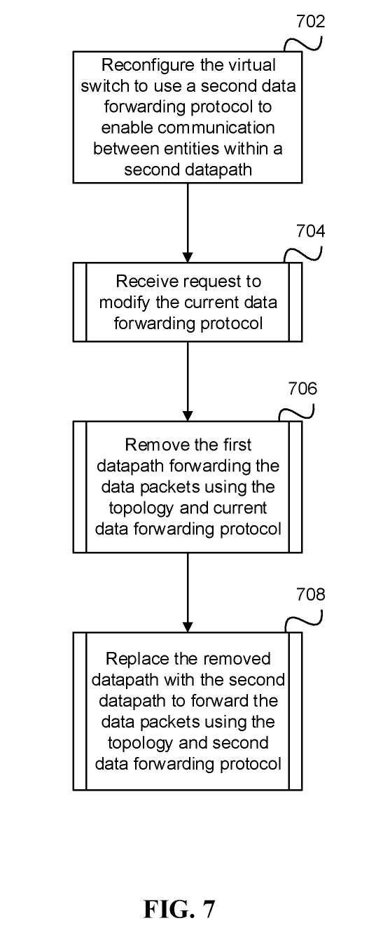

FIG. 7 illustrates another flow diagram for configuring a virtual switch with multiple protocols using a pluggable software module (plugin) in accordance with FIGS. 1-5. Recall in the process of FIG. 4 that provider A has two protocols, namely protocol1 and protocol2. At 702, the VS framework 204 reconfigures the virtual switch to use the second flow management protocol (protocol2) to enable communication among the entities attached to each for the network interfaces by forwarding data packets within a second datapath (dp1) using the second flow management protocol.

In reconfiguring the virtual switch, the VS framework 204 receives a request from the configurator 202 to modify (e.g., change or update) the first flow management protocol (“protocol1”) to a second flow management protocol (“protocol2”) at 704. The data plane 206B, similar to above, is identified by the VS framework 204 as a modified plugin with a changed or updated flow management protocol. To change or update flow management protocols requested at 704, the VS framework 204 forwards the request from the configurator 202 to remove the first datapath (dp1) to the data plane provider 206 at 706. The first datapth (dp1) is then removed.

Subsequently, the VS framework 204 requests that a new (second) datapath (dp1) be created to enable the second flow management protocol (protocol2), while maintaining the topology of the virtual switch (VS) 206C. This is accomplished by configuring the virtual switch (VS) 206C to implement the second flow management protocol (“protocol2”) which could be enabled by an updated or modified plugin to establish the communication. That is, the virtual switch (VS) 206C is configured to implement the second flow management protocol (“protocol2”) by replacing the first flow management protocol (“protocol1”) at 708. Entities attached to the first (“if1”) and second (“if2”) network interfaces are now able to communicate using the second flow management protocol (“protocol2”).

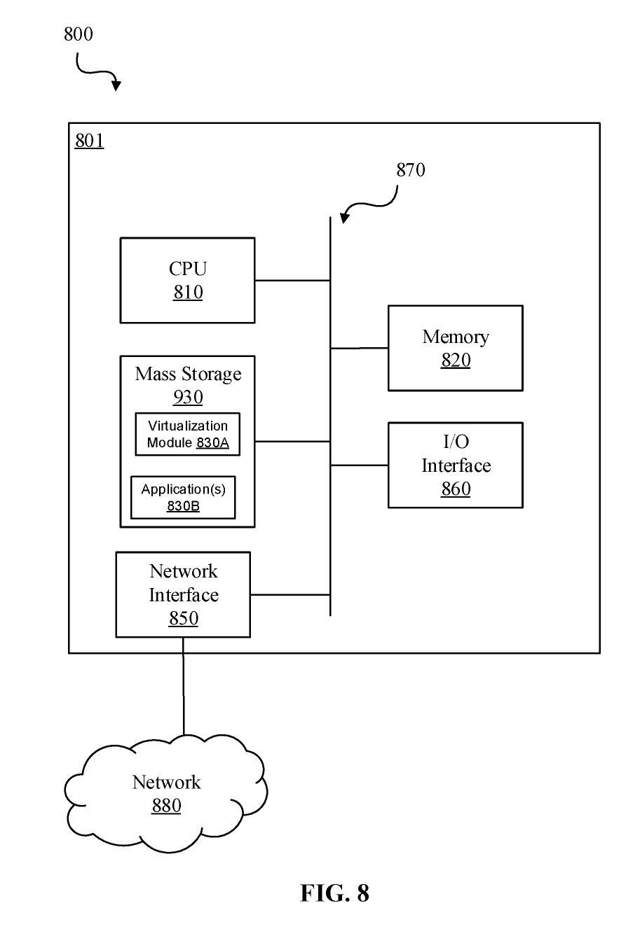

FIG. 8 is a block diagram of a network system that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The network system may comprise a processing unit 801 equipped with one or more input/output devices, such as network interfaces, storage interfaces, and the like. The processing unit 801 may include a central processing unit (CPU) 810, a memory 820, a mass storage device 830, and an I/O interface 860 connected to a bus 870. The bus 870 may be one or more of any type of several bus architectures including a memory bus or memory controller, a peripheral bus or the like. The CPU 810 may comprise any type of electronic data processor, which may be configured to read and process instructions stored in the memory 820.

The memory 820 may comprise any type of system memory such as static random access memory (SRAM), dynamic random access memory (DRAM), synchronous DRAM (SDRAM), read-only memory (ROM), a combination thereof, or the like. In an embodiment, the memory 820 may include ROM for use at boot-up, and DRAM for program and data storage for use while executing programs. In embodiments, the memory 820 is non-transitory.

The mass storage device 830 may comprise any type of storage device configured to store data, programs, and other information and to make the data, programs, and other information accessible via the bus. The mass storage device 830 may comprise, for example, one or more of a solid state drive, hard disk drive, a magnetic disk drive, an optical disk drive, or the like.

The mass storage device 830 may also include a virtualization module 830A and application(s) 830B. Virtualization module 830A may represent, for example, a hypervisor of a computing device 108A, and applications 830B may represent different VMs. The virtualization module 830A may include a switch (not shown) to switch packets on one or more virtual networks and be operable to determine physical network paths. Applications 830B may each include program instructions and/or data that are executable by computing device 108A. As one example, application(s) 830B may include instructions that cause computing device 108A to perform one or more of the operations and actions described in the present disclosure.

The processing unit 801 also includes one or more network interfaces 850, which may comprise wired links, such as an Ethernet cable or the like, and/or wireless links to access nodes or one or more networks 880. The network interface 850 allows the processing unit 801 to communicate with remote units via the networks 880. For example, the network interface 850 may provide wireless communication via one or more transmitters/transmit antennas and one or more receivers/receive antennas. In an embodiment, the processing unit 801 is coupled to a local-area network or a wide-area network for data processing and communications with remote devices, such as other processing units, the Internet, remote storage facilities, or the like.

As a result of the virtual switch framework with pluggable flow management modules discussed above, several advantages are provided including, but not limited to, changing or updating underlying switching protocols without interrupting the network operations based on the running switch topology, new switching protocols or providers can be added at runtime without affecting currently active switching providers and protocols on the system, use existing common topology management functionalities provided by the framework, a unified system to manage multiple different types of virtual switches, eliminating operation down time for service providers and users given the ability to change or update underlying switching protocols without interrupting virtual networking operations, reducing time and cost of developing new protocol providers given the common topology management functionalities provided by the framework implementation of new switch protocol providers, reducing the complicity of switch management and operator's learning curve given the unified interfaces that can be used for managing multiple different types of virtual switches, and reducing human errors when changing switch protocols since the switch object and its topology configuration can be retained without reconfiguration.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for supporting multiple flow management protocols in a network switch, comprising:
detecting a data plane provider, the data plane provider discoverable via a pluggable software module that identifies a data plane of the data plane provider with one or more network interfaces and enables one or more flow management protocols; and
configuring a virtual switch to use a first flow management protocol of the one or more flow management protocols enabled by the pluggable software module by
constructing a topology of the virtual switch by creating a virtual switch object on a virtual switch framework, and adding one or more ports to the virtual switch to form the topology;
creating a first datapath on the data plane provider using the topology with the first flow management protocol; and
connecting a first network interfaces of the one or more network interfaces to a first port of the one or more ports and a second network interface of the one or more network interfaces to a second port of the one or more ports to enable communication among one or more entities attached to each of the network interfaces by forwarding data packets within the first datapath using the first flow management protocol.

2. The method of claim 1, wherein the pluggable software module further identifies the data plane with a second flow management protocol,
the method further comprising:
reconfiguring the virtual switch to use a second flow management protocol of the one or more flow management protocols enabled by the pluggable software module to enable communication among the entities attached to each of the network interfaces by forwarding data packets within a second datapath using the second flow management protocol by:
receiving a request to modify the first flow management protocol to the second flow management protocol;
removing the first datapath forwarding the data packets using the topology and first flow management protocol; and
replacing the removed first datapath with the second datapath to forward the data packets using the topology and the second flow management protocol.

3. The method of claim 2, wherein the virtual switch is reconfigurable with the first and second flow management protocols during runtime without changing the topology of the virtual switch.

4. The method of claim 2, further comprising:
adding a third port of the one or more ports to the virtual switch; and
connecting a third network interface of the one or more network interfaces to the third port to enable communication among the one or more entities attached to each of the one or more network interfaces by forwarding the data packets within the first datapath using the first flow management protocol.

5. The method of claim 2, further comprising:
adding a third port of the one or more ports to the virtual switch; and
connecting a third network interface of the one or more network interfaces to the third port to enable communication among the one or more entities attached to each of the one or more network interfaces by forwarding the data packets within the second datapath using the second flow management protocol.

6. The method of claim 2, wherein the entities are at least one of virtual machines, namespaces and containers.

7. The method of claim 1, further comprising storing the pluggable software module of the data plane provider in a data store.

8. The method of claim 1, wherein the detecting comprises discovering the pluggable software module by monitoring the data store for at least one of newly added plugins for enabling at least one of new flow management protocols and updating the flow management protocols of the data plane providers.

9. The method of claim 2, wherein the pluggable software module of the data plane is dynamically loadable during runtime to enable at least one of adding another flow management protocol to the data plane provider and changing one of the first and second flow management protocols of the virtual switch without reconfiguring the topology of the virtual switch.

10. The method of claim 1, wherein the network interface is one of a virtual network interface and a physical network interface.

11. A non-transitory computer-readable medium storing computer instructions for supporting multiple protocols in a network, that when executed by one or more processors, perform the steps of:
detecting a data plane provider, the data plane provider discoverable via a pluggable software module that identifies a data plane of the data plane provider with one or more network interfaces and enables one or more flow management protocols; and
configuring a virtual switch to use a first flow management protocol of the one or more flow management protocols enabled by the pluggable software module by:
constructing a topology of the virtual switch by creating a virtual switch object on a virtual switch framework, and adding one or more ports to the virtual switch;
creating a first datapath on the data plane provider using the topology with the first flow management protocol; and
connecting a first network interface of the one or more network interfaces to a first port of the one or more ports and a second network interface of the one or more network interfaces to a second port of the one or more ports to enable communication among one or more entities attached to each of the network interfaces by forwarding data packets within the first datapath using the first flow management protocol.

12. The non-transitory computer-readable medium of claim 11, wherein the pluggable software module further identifies the data plane with a second flow management protocol, and
the method further comprising:
reconfiguring the virtual switch to use a second flow management protocol of the one or more flow management protocols enabled by the pluggable software module to enable communication among the entities attached to each of the network interfaces by forwarding data packets within a second datapath using the second flow management protocol by:
receiving a request to modify the first flow management protocol to the second flow management protocol;
removing the first datapath forwarding the data packets using the topology and first flow management protocol; and
replacing the removed first datapath with the second datapath to forward the data packets using the topology and the second flow management protocol.

13. The non-transitory computer-readable medium of claim 12, wherein the virtual switch is reconfigurable with the first and second flow management protocols during runtime without changing the topology of the virtual switch.

14. The non-transitory computer-readable medium of claim 12, further comprising:
adding a third port of the one or more ports to the virtual switch; and
connecting a third network interface of the one or more network interfaces to the third port to enable communication among the one or more entities attached to each of the one or more network interfaces by forwarding the data packets within the first datapath using the first flow management protocol.

15. The non-transitory computer-readable medium of claim 12, further comprising:
adding a third port of the one or more ports to the virtual switch; and
connecting a third network interface of the one or more network interfaces to the third port to enable communication among the one or more entities attached to each of the one or more network interfaces by forwarding the data packets within the second datapath using the second flow management protocol.

16. The non-transitory computer-readable medium of claim 12, wherein the entities are at least one of virtual machines, namespaces and containers.

17. The non-transitory computer-readable medium of claim 11, further comprising storing the pluggable software module of the data plane provider in a data store.

18. The non-transitory computer-readable medium of claim 11, wherein the detecting comprises discovering the pluggable software module by monitoring the data store for at least one of newly added plugins for updated data planes of the data plane providers.

19. The non-transitory computer-readable medium of claim 12, wherein the pluggable software module of the data plane is dynamically loadable during runtime to enable at least one of adding another flow management protocol to the data plane provider and changing one of the first and second flow management protocols of the virtual switch without reconfiguring the topology of the virtual switch.

20. The non-transitory computer-readable medium of claim 11, wherein the network interface is a virtual network interface.

21. A node for supporting multiple protocols in a network, comprising:
a memory storage comprising instructions; and
one or more processors coupled to the memory that execute the instructions to:
detect a data plane provider, the data plane provider discoverable via a pluggable software module that identifies a data plane of the data plane provider with one or more network interfaces and enables one or more flow management protocols; and
configure a virtual switch to use a first flow management protocol of the one or more flow management protocols enabled by the pluggable software module by
constructing a topology of the virtual switch by creating a virtual switch object on a virtual switch framework, and adding one or more ports to the virtual switch;
creating a first datapath on the data plane provider using the topology with the first flow management protocol; and
connecting a first network interface of the one or more network interfaces to a first port of the one or more ports and a second network interface of the one or more network interfaces to a second port of the one or more ports to enable communication among one or more entities attached to each of the network interfaces by forwarding data packets within the first datapath using the first flow management protocol.

22. The node of claim 21, wherein the pluggable software module further identifies the data plane with a second flow management protocol, and
the one or more processors coupled to the memory that further execute the instructions to:
reconfigure the virtual switch to use a second flow management protocol of the one or more flow management protocols enabled by the pluggable software module to enable communication among the entities attached to each of the network interfaces by forwarding data packets within a second datapath using the second flow management protocol by:
receiving a request to modify the first flow management protocol to the second flow management protocol;
removing the first datapath forwarding the data packets using the topology and first flow management protocol; and
replacing the removed first datapath with the second datapath to forward the data packets using the topology and the second flow management protocol.

23. The node of claim 22, wherein the virtual switch is reconfigurable with the first and second flow management protocols during runtime without changing the topology of the virtual switch.
